(19) United States
(12) Patent Application Publication
(10) Pub. No.: US 2019/0030619 A1
(43) Pub. Date: Jan. 31, 2019

(54) POCKET HOLE JIG

(71) Applicant: TTI (MACAO COMMERCIAL OFFSHORE) LIMITED, Macau (MO)

(72) Inventor: Clinton C. Thackery, Clemson, SC (US)

(21) Appl. No.: 16/046,216

(22) Filed: Jul. 26, 2018

Related U.S. Application Data
(60) Provisional application No. 62/538,071, filed on Jul. 28, 2017.

(51) Int. Cl. B23B 47/28; B23B 49/00

(52) U.S. Cl. CPC B23B 47/287; B23B 2247/12; B23B 49/005

(57) ABSTRACT

A pocket hole jig includes a base with a body and a guide holder extending from the body. A clamp assembly is coupled to the base and includes a carriage movable relative to the base and a clamp arm coupled to the carriage. The pocket hole jig also includes a drill guide assembly supported by the guide holder and having a slanted bore configured to receive a drill bit to facilitate drilling a pocket hole in a workpiece. Movement of the carriage relative to the base in a first direction moves the drill guide assembly in a second direction different than the first direction.

### CROSS-REFERENCE TO RELATED APPLICATIONS

This application claims priority to co-pending U.S. Provisional Patent Application No. 62/538,071 filed on Jul. 28, 2017, the entire content of which is incorporated herein by reference.

### BACKGROUND

The present disclosure relates to pocket hole jigs, and more particularly to pocket hole jigs that are adjustable to accommodate workpieces of different thicknesses.

### SUMMARY

The present disclosure provides, in one aspect, a pocket hole jig including a base with a body and a guide holder extending from the body. A clamp assembly is coupled to the base and includes a carriage movable relative to the base and a clamp arm coupled to the carriage. The pocket hole jig also includes a drill guide assembly supported by the guide holder and having a slanted bore configured to receive a drill bit to facilitate drilling a pocket hole in a workpiece. Movement of the carriage relative to the base in a first direction moves the drill guide assembly in a second direction different than the first direction.

The present disclosure provides, in another aspect, a pocket hole jig including a base with a body and a guide holder extending from the body, a clamp arm movably coupled to the base, and a drill guide assembly supported by the guide holder. The drill guide assembly includes a slanted bore configured to receive a drill bit to facilitate drilling a pocket hole in a workpiece. Movement of the clamp arm relative to the base moves the drill guide assembly relative to the guide holder.

The present disclosure provides, in another aspect, a pocket hole jig including a base with a body and a guide holder extending from the body. A clamp assembly is coupled to the base and includes a carriage movable relative to the base and a clamp arm coupled to the carriage. The pocket hole jig also includes a drill guide assembly supported by the guide holder and having a slanted bore configured to receive a drill bit to facilitate drilling a pocket hole in a workpiece. Movement of the carriage relative to the base at a first rate moves the drill guide assembly relative to the guide holder at a second rate different than the first rate.

The present disclosure provides, in another aspect, a pocket hole jig including a base and a clamp assembly coupled to the base. The base includes a guide holder extending upwardly from a main body of the base, and the clamp assembly includes a carriage movable along the main body, an actuator, and a rod extending along the main body between the carriage and the actuator. The pocket hole jig further includes a drill guide assembly slidably received by the guide holder. The drill guide assembly includes at least one slanted bore extending therethrough for guiding a drill bit. The drill guide assembly and the clamp assembly are interconnected such that movement of the carriage to clamp a workpiece of a particular thickness automatically positions the drill guide assembly in a predetermined position corresponding to that thickness.

Other features and aspects of the disclosure will become apparent by consideration of the following detailed description and accompanying drawings.

### BRIEF DESCRIPTION OF THE DRAWINGS

FIG. 1 is a perspective view of a pocket hole jig according to one embodiment of the disclosure.

FIG. 2 is an exploded view of the pocket hole jig of FIG. 1.

FIG. 3 is a cross-sectional view of the pocket hole jig of FIG. 1 taken along line 3-3 in FIG. 1.

FIG. 4 is perspective view of a drill guide assembly of the pocket hole jig of FIG. 1.

FIG. 5 is an exploded view of the drill guide assembly of FIG. 4.

FIG. 6 is a perspective view of an adjustment mechanism of the pocket hole jig of FIG. 1.

FIG. 7 is a side view illustrating a first position of the drill guide assembly corresponding with a first position of a clamp assembly of the pocket hole jig of FIG. 1.

FIG. 8 is a side view illustrating a second position of the drill guide assembly corresponding with a second position of the clamp assembly.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

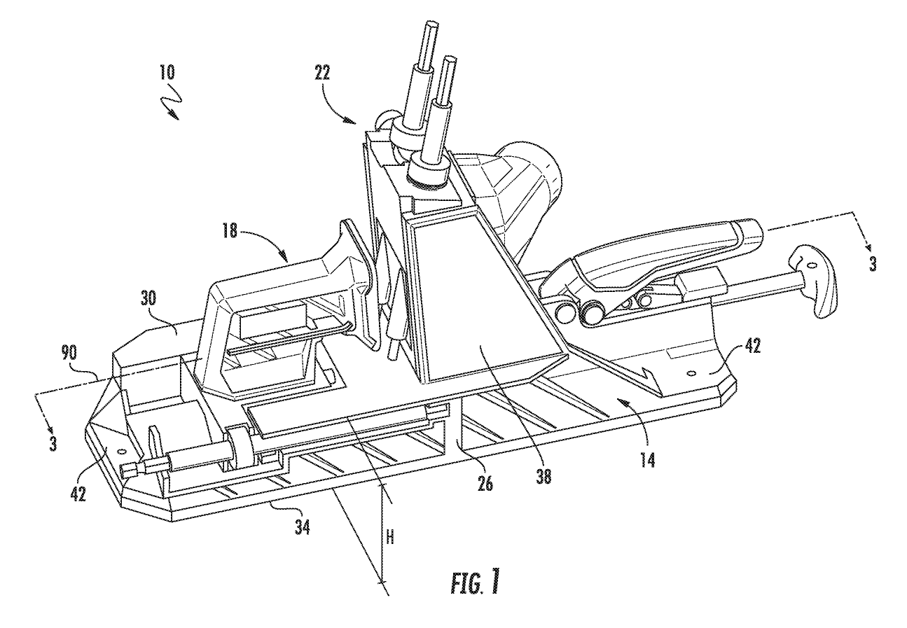

FIG. 1 illustrates a pocket hole jig 10 according to one embodiment. The jig 10 includes a base 14, a clamp assembly 18, and a drill guide assembly 22. The base 14 includes a main body 26 having an upper surface 30, a lower surface 34 opposite the upper surface 30, and a guide holder 38 that projects upwardly from the upper surface 30. The upper surface 30 is substantially planar and is configured to support a workpiece (not shown). In the illustrated embodiment, the lower surface 34 is substantially planar and extends parallel with the upper surface 30. The planar lower surface 34 allows the base 14 to be set and used on a flat work surface (not shown), and the illustrated base 14 includes a plurality of clamp surfaces 42 between the lower surface 34 and the upper surface 30 to facilitate clamping the base 14 to the work surface. The main body 26 and the guide holder 38 are integrally formed together as a single piece (e.g., via a molding process). In other embodiments, the guide holder 38 and the main body 26 may be separate components fastened together by adhesive, welding, mechanical fasteners, or any other suitable means.

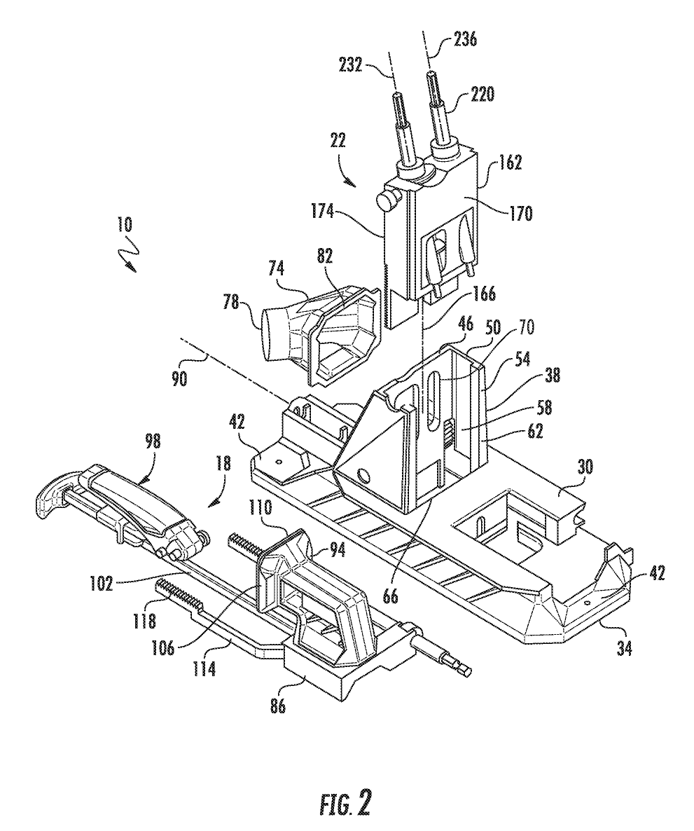

Referring to FIG. 2, the illustrated guide holder 38 includes a back wall 46, parallel side walls 50 extending forward from the back wall 46, and front walls 54 extending inwardly from the side walls 50. A vertical slot or track 58 is defined between the back wall 46 and each of the front walls 54. Each of the front walls 54 includes a front surface 62 that is substantially perpendicular to the upper surface 30 of the main body 26. In the illustrated embodiment, the guided holder 38 includes an opening 66 at its bottom end and a pair of elongated openings 70 extending through the back wall 46. The openings 70 may facilitate the egress of dust and debris generated during a drilling operation.

The illustrated pocket hole jig 10 further includes a dust collector nozzle 74 coupled to a the back wall 46 of the guide holder 38. In some embodiments, the dust collector nozzle 74 is removably coupled to the back wall 46 to allow the pocket hole jig 10 to be used with or without the dust collector nozzle 74. In some embodiments, the dust collector nozzle 74 may be integrally formed with the guide holder 38. In other embodiments, the dust collector nozzle 74 may be omitted. The dust collector nozzle 74 includes a port 78 for connection to a vacuum hose (not shown) and an inlet 82 that overlies the elongated openings 70 in the back wall 46 of the guide holder 38. Dust and debris generated during a drilling operation may be drawn out through the elongated openings 70, into the dust collector nozzle 74, and finally discharged through the port 78. In the illustrated embodiment, the port 78 is oriented at an oblique angle relative to the inlet 82.

With continued reference to FIG. 2, the clamp assembly 18 includes a carriage 86 that is movable relative to the base along a longitudinal clamping axis 90 (FIG. 1), a clamp arm 94 fixed to the carriage 86, an actuator assembly 98, and a rod 102 extending from the carriage 86 to the actuator assembly 98. The clamp arm 94 includes a pad 106 that defines a first clamping surface 110 oriented substantially perpendicular to the clamping axis 90 and to the upper surface 30 of the main body 26. First and second arms 114 extend from the carriage 86 toward the actuator assembly 98, in a direction generally parallel with the rod 102. Each of the arms 114 includes a rack gear portion 118 that is part of an adjustment assembly 300 of the pocket hole jig 10 described in greater detail below. In the illustrated embodiment, the rod 102 is centered between the arms 114.

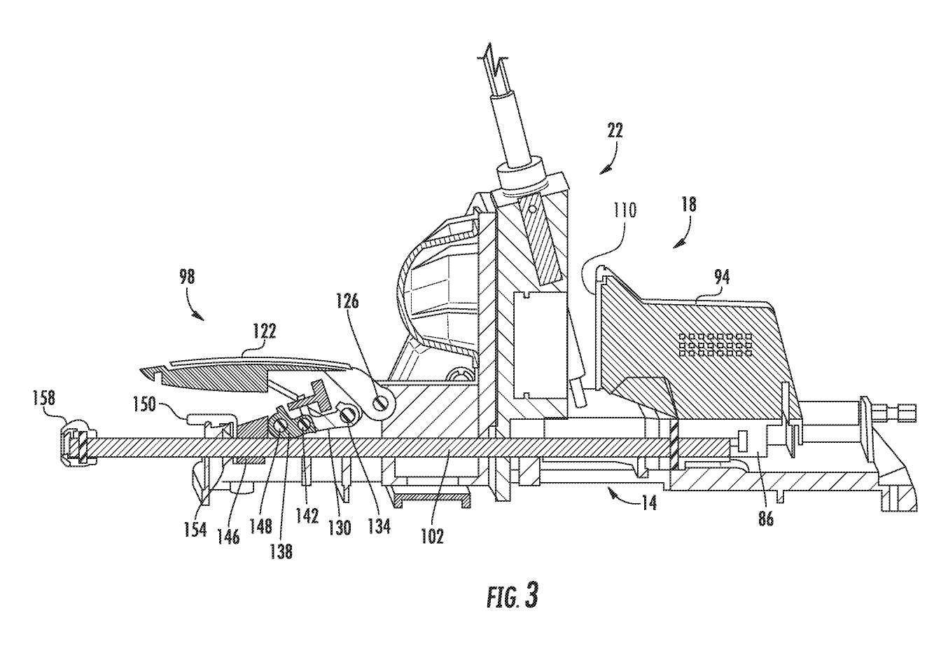

Best illustrated in FIG. 3, the actuator assembly 98 includes a lever 122 pivotally coupled to the base 14 by a first pin 126, a link 130 pivotally to the lever 122 by a second pin 134, a cam 138 pivotally coupled to the link 130 by a third pin 142, a locking element 146 pivotally coupled to the cam 138 by a fourth pin 148, a release member 150, and a spring 154 disposed between the release member 150 and the base 14. The rod 102 extends through bores in the locking element 146 and the release member 150 and terminates at a generally T-shaped handle 158. In operation, with the lever 122 in a raised position (not shown), the user may slide the carriage 86 and clamp arm 94 along the clamping axis 90 by grasping the handle 158 and pushing or pulling. To clamp a workpiece, the user positions the workpiece against the drill guide assembly 22 and pulls the handle 158 to engage the first clamping surface 110 against the workpiece. The user then pivots lever 122 downward. The lever 122, link 130, and cam 138 are arranged as an over-center linkage and push backward on the locking element 146 (left in the orientation illustrated in FIG. 3). Due to frictional engagement between the locking element 146 and the rod 102, the pressure on the locking element 146 draws the clamp arm 94 toward the workpiece to apply a clamping force to the workpiece. To release the clamping force, the user lifts up on the release member 150, which reduces the frictional engagement between the locking element 146 and the rod 102.

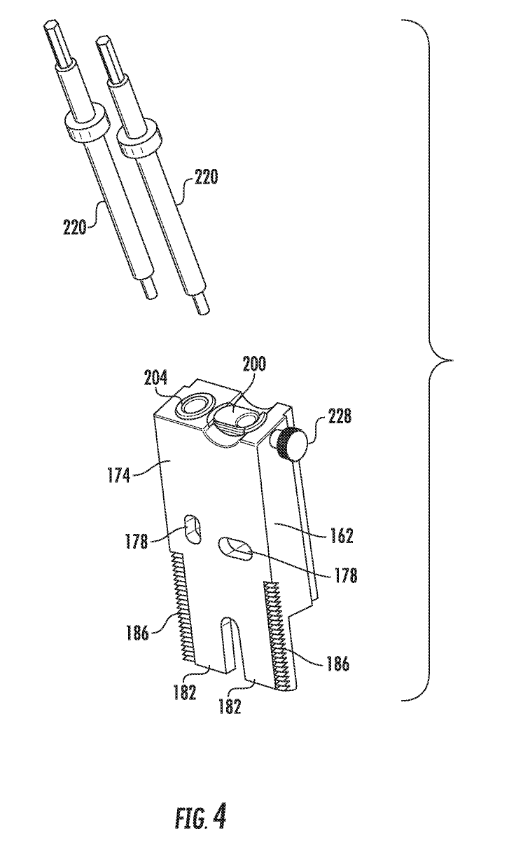

Referring to FIG. 2, the illustrated drill guide assembly 22 includes a guide block 162 that is received within the guide holder 38. In the illustrated embodiment, the guide block 162 is slidable along an adjustment axis 166 that is substantially perpendicular to the clamping axis 90 and to the upper surface 30 of the main body 26. The guide block 162 includes a planar front surface or second clamping surface 170 that is substantially parallel to the first clamping surface 110 on the clamp arm 94 such that a workpiece may be clamped between the first and second clamping surfaces 110, 170. A rear surface 174 of the guide block 162 is positioned adjacent the rear wall 46 of the guide holder 38. In the illustrated embodiment, openings 178 extend through the rear surface 174 (FIG. 4) and are generally aligned with the elongated openings 70 in the rear wall 46 of the guide holder 38 (FIG. 2) to facilitate the egress of dust and debris generated during a drilling operation. The guide block 162 further includes first and second downwardly-extending arms 182 (FIG. 4). Each of the arms 182 includes a rack gear portion 186 that is part of the adjustment assembly 300 described in greater detail below.

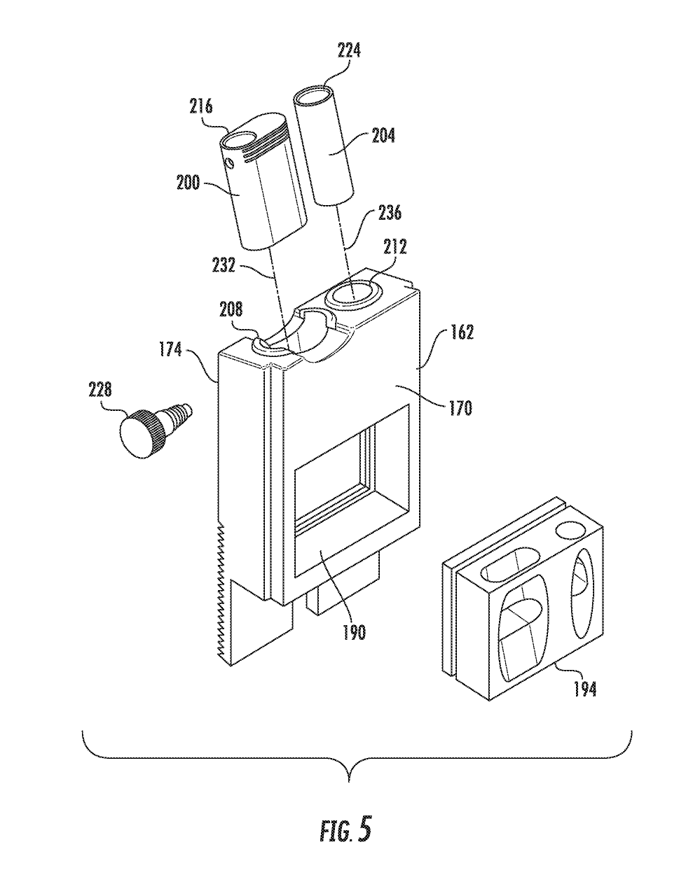

Referring to FIG. 5, the guide block 162 further includes a generally rectangular recess 190 extending inwardly from the front surface 170 toward the rear surface 174. An insert 194 is received within the recess 190. The insert 194 is located in the region where a drill bit would enter the workpiece during a pocket hole drilling operation. In some embodiments, the guide block 162 may be made of plastic and the insert 194 may be made of metal. Thus, the insert 194 advantageously provides higher durability in the drilling region while allowing the remainder of the guide block 162 to be made of lighter weight and/or less costly material. In some embodiments, the insert 194 may be removable and replaceable. In other embodiments, the insert 194 may be permanently fixed within the receptacle 190.

The illustrated drill guide assembly 162 further includes first and second bushings 200, 204 received within first and second angled bores 208, 212 formed in the guide block 162 (FIGS. 4 and 5). The first bushing 200 includes a first cylindrical passage 216 for guiding a drill bit 220, and the second bushing 204 includes a second cylindrical passage 224 for guiding the drill bit 220 (FIG. 5). In the illustrated embodiment, the first bushing 200 has an oval shape and is reversible relative to the first angled bore 208 to provide two different positions for the first cylindrical passage 216. Thus, the first bushing 200 is movable between a first position (illustrated in FIGS. 4 and 5) to provide a first predetermined spacing between the first and second cylindrical passages 216, 224 and a second position (not shown) to provide a second, different predetermined spacing between the first and second cylindrical passages 216, 224. In some embodiments, the first spacing may be between about 1 inch and about 2 inches, and the second spacing may be between about 1.5 inches and about 2.5 inches. In the illustrated embodiment, a thumb screw 228 is provided to secure the first bushing 200 in either the first position or the second position.

The guide block 162, the insert 194, and the bushings 200, 204 collectively define first and second guide channels of the drill guide assembly that extend at an oblique angle along respective parallel, spaced axes 232, 236. The slanted guide channels are configured to guide the drill bit 220 at an appropriate angle to form a pocket hole in a workpiece clamped between the first and second clamping surfaces 110, 170 (FIG. 2). In the illustrated embodiment, the drill guide assembly 22 includes two guide channels. In other embodiments, the drill guide assembly 22 may include a single guide channel or may include more than two guide channels.

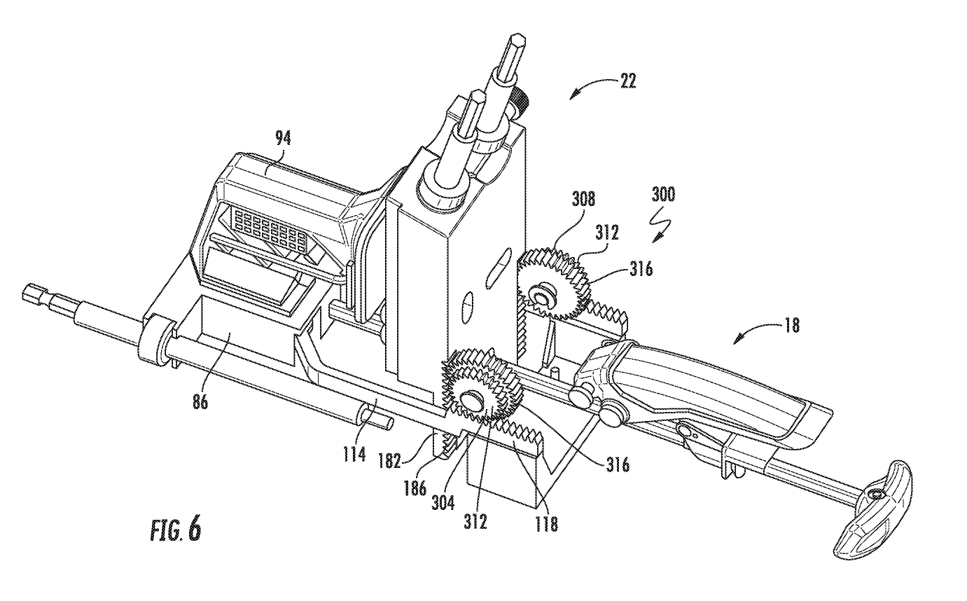

With reference to FIG. 6, the pocket hole jig 10 further includes an adjustment mechanism 300 that interconnects the clamp assembly 18 and the drill guide assembly 22 such that movement of the carriage 86 and clamp arm 94 to clamp a workpiece of a particular thickness automatically positions the drill guide assembly 22 in an predetermined position corresponding to that thickness. The adjustment mechanism 300 includes first and second compound gears 304, 308 rotatably coupled to the base 14. Each of the compound gears 304, 308 includes a first pinion 312 or toothed portion having a first diameter and a second pinion 316 or toothed portion having a second diameter greater than the first diameter. In the illustrated embodiment, the first pinions 312 are meshed with the rack portions 118 of the arms coupled 114 to the carriage 86. The second pinions 316 are meshed with the rack portions 186 of the guide block arms 182. Accordingly, the compound gears 304, 308 convert horizontal movement of the carriage 86 and clamp arm 94 at a first rate into vertical movement of the drill guide assembly 22 at a second rate. Because the second diameter is greater than the first diameter, the second rate is less than the first rate. The first and second diameters are sized to correlate the thickness of the workpiece with the appropriate height of the drill guide assembly 22.

In addition to facilitating efficient and convenient adjustment of the drill guide assembly 22, the illustrated embodiment of the adjustment mechanism 300 enables the pocket hole jig 10 to have a relatively thin base 14. With reference to FIG. 1, the base 14 defines a thickness or height H measured between the upper and lower surfaces 30, 34. In the illustrated embodiment, the height H is about 1.5 inches; however, in other embodiments, the height H may vary. In addition to being relatively compact, the 1.5 inch height H permits the upper surface 30 of the base 14 to sit flush with the upper surface of adjacent standard 1.5-inch thick material. Accordingly, commonly-found materials can be used to effectively extend the upper surface of the base 14, which may provide increased stability when positioning large workpieces on the base 14 of the pocket hole jig 10.

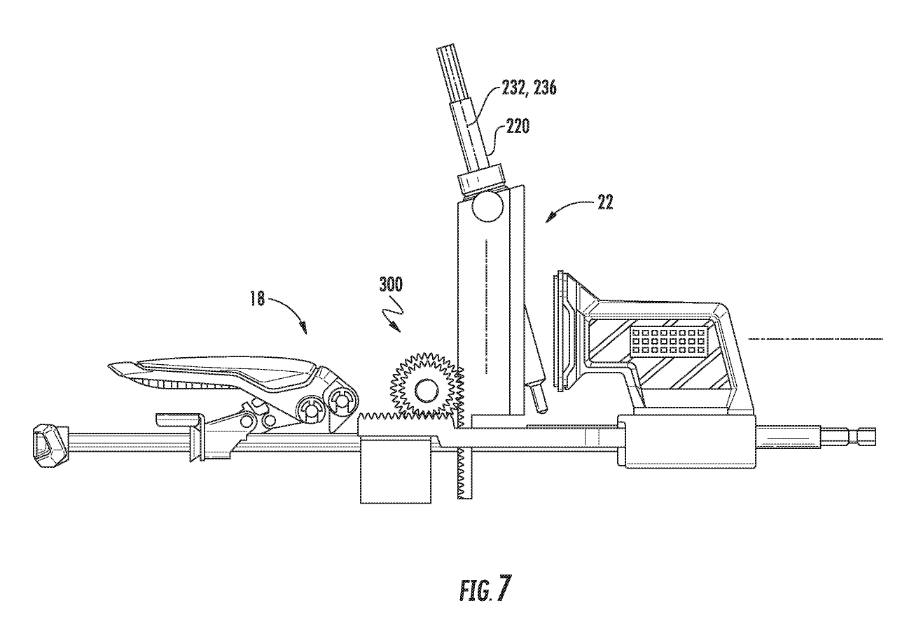

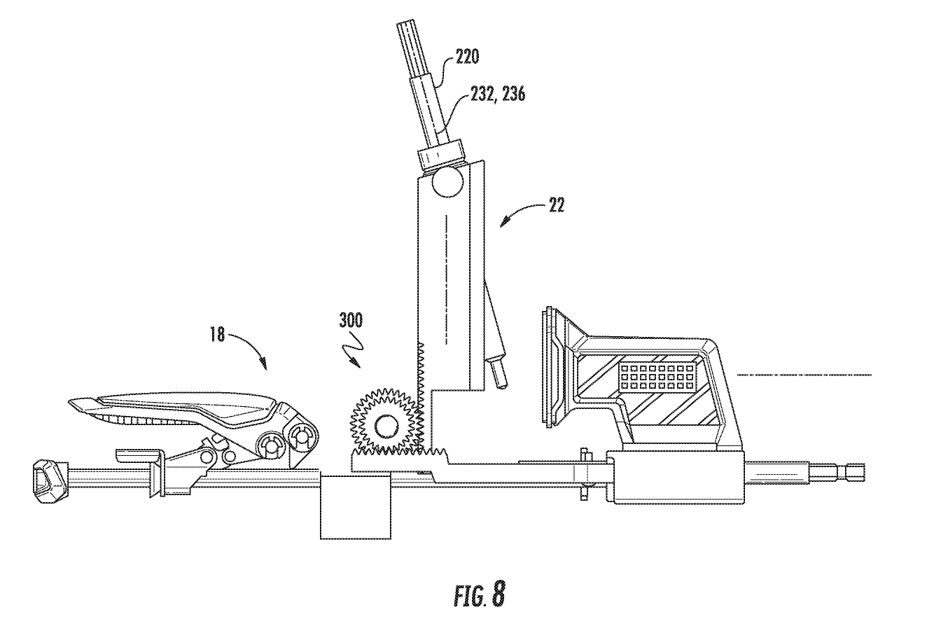

In operation, with reference to FIGS. 7 and 8, when the user clamps a workpiece of a particular thickness with the clamp assembly 18, the adjustment mechanism 300 automatically sets the height of the drill guide assembly 22 to a proper level for the workpiece thickness. The user can the insert the drill bit 220 through the cylindrical passages 216, 224 (FIG. 5) and drill pocket holes in the workpiece along the axes 232, 236.

Various features of the invention are set forth in the following claims.

What is claimed is:

1. A pocket hole jig comprising:
a base including a body and a guide holder extending from the body;
a clamp assembly coupled to the base, the clamp assembly including a carriage movable relative to the base and a clamp arm coupled to the carriage; and
a drill guide assembly supported by the guide holder, the drill guide assembly including a slanted bore configured to receive a drill bit to facilitate drilling a pocket hole in a workpiece,
wherein the carriage and the drill guide assembly are interconnected such that movement of the carriage relative to the base in a first direction moves the drill guide assembly in a second direction different than the first direction.

2. The pocket hole jig of claim 1, further comprising an adjustment mechanism interconnecting the carriage with the drill guide assembly, wherein the adjustment mechanism includes a first rack gear on a first arm extending from the carriage and a second rack gear on a second arm extending from the drill guide assembly.

3. The pocket hole jig of claim 2, wherein the adjustment mechanism further includes a gear rotatably coupled to the base, the gear meshed with the first rack gear and the second rack gear.

4. The pocket hole jig of claim 3, wherein the gear is a compound gear.

5. The pocket hole jig of claim 1, wherein movement of the carriage relative to the base in the first direction at a first rate moves the drill guide assembly in the second direction at a second rate different than the first rate.

6. The pocket hole jig of claim 1, wherein the clamp assembly further includes an actuator coupled to the base and a rod extending between the actuator and the carriage.

7. A pocket hole jig comprising:
a base including a body and a guide holder extending from the body;
a clamp arm movably coupled to the base; and
a drill guide assembly supported by the guide holder, the drill guide assembly including a slanted bore configured to receive a drill bit to facilitate drilling a pocket hole in a workpiece;
wherein the clamp arm and the drill guide assembly are interconnected such that movement of the clamp arm relative to the base moves the drill guide assembly relative to the guide holder.

8. The pocket hole jig of claim 7, further comprising an adjustment mechanism including a first rack gear coupled to the clamp arm and a second rack gear coupled to the drill guide assembly.

9. The pocket hole jig of claim 8, wherein the adjustment mechanism further includes a gear rotatably coupled to the base, the gear meshed with the first rack gear and the second rack gear.

10. The pocket hole jig of claim 9, wherein the gear includes a first toothed portion defining a first diameter and meshed with the first rack gear, and a second toothed portion defining a second diameter different than the first diameter and meshed with the second rack gear.

11. The pocket hole jig of claim 10, wherein the first diameter is less than the second diameter.

12. The pocket hole jig of claim 7, wherein the guide holder includes a back wall, first and second parallel side walls extending from the back wall, and first and second front walls extending inwardly from the respective first and second side walls.

13. The pocket hole jig of claim 12, further comprising an opening extending through the back wall.

14. The pocket hole jig of claim 13, further comprising a dust collection nozzle coupled to the guide holder, wherein the dust collection nozzle is in fluid communication with the opening.

15. A pocket hole jig comprising:
a base including a body and a guide holder extending from the body;
a clamp assembly coupled to the base, the clamp assembly including a carriage movable relative to the base and a clamp arm coupled to the carriage; and
a drill guide assembly supported by the guide holder, the drill guide assembly including a slanted bore configured to receive a drill bit to facilitate drilling a pocket hole in a workpiece,
wherein the carriage and the drill guide assembly are interconnected such that movement of the carriage relative to the base at a first rate moves the drill guide assembly relative to the guide holder at a second rate different than the first rate.

16. The pocket hole jig of claim 15, further comprising an adjustment mechanism including a first rack gear coupled to the carriage and a second rack gear coupled to the drill guide assembly.

17. The pocket hole jig of claim 16, wherein the adjustment mechanism further includes a gear rotatably coupled to the base, the gear meshed with the first rack gear and the second rack gear.

18. The pocket hole jig of claim 17, wherein the gear includes a first toothed portion defining a first diameter and meshed with the first rack gear and a second toothed portion defining a second diameter different than the first diameter and meshed with the second rack gear.

19. The pocket hole jig of claim 18, wherein the first diameter is less than the second diameter.

20. The pocket hole jig of claim 15, wherein the drill guide assembly includes a guide block made of plastic and an insert made of metal, and wherein the bore extends through both the guide block and the insert.
